(19) United States
(12) Patent Application Publication
(10) Pub. No.: US 2011/0221612 A1
(43) Pub. Date: Sep. 15, 2011

(54) TRAFFIC SIGN NOTIFICATION SYSTEM AND METHOD FOR THE SAME

(75) Inventor: Kenichi FUSE, Hadano-shi (JP)

(73) Assignee: EMPIRE TECHNOLOGY DEVELOPMENT LLC, Wilmington, DE (US)

(21) Appl. No.: 12/968,926

(22) Filed: Dec. 15, 2010

(30) Foreign Application Priority Data
Mar. 15, 2010 (JP) 2010-057927

(51) Int. Cl. G08G 1/09

(52) U.S. Cl. 340/905

(57) ABSTRACT

In an embodiment, a traffic sign notification system is configured to notify a driver of a moving vehicle regarding the presence of a traffic sign. The traffic sign notification system may include a traffic sign including a traffic sign body attached to a pole, and a transmission apparatus configured to transmit a signal with predetermined electric power for notifying an automobile regarding the presence of the traffic sign. A notification apparatus is provided at the automobile. The notification apparatus is configured to generate a notification regarding the presence of the traffic sign to the driver of the automobile 10 in response to receiving the signal.

### CROSS-REFERENCE TO RELATED APPLICATIONS

This application claims priority to Japanese Patent Application No. 2010-057927 filed Mar. 15, 2010, which is incorporated herein by reference in its entirety.

1. Technical Field

Embodiments disclosed herein relate to a traffic sign notification system configured to notify a driver regarding the presence of a traffic sign, and a method therefor.

2. Background

Drivers tend to miss traffic signs, as noted at http://www.toyota.co.jp/mobilitas/anzen/vol28_{—}2.html.

The present application for patent is made in view of the above-mentioned background, and discloses embodiments of a traffic sign notification system configured to notify a driver of a vehicle such as an automobile about the presence of a traffic sign, and a method therefor.

### BRIEF SUMMARY

In some embodiments disclosed herein, a traffic sign notification system includes a traffic sign; a transmission apparatus provided at a position related to the traffic sign and configured to transmit a signal indicating the presence of the traffic sign, the signal having predetermined electric power; and a notification apparatus provided at a moving vehicle. The notification apparatus may include a reception unit configured to receive the signal; and a notification unit configured to generate a notification regarding the presence of the traffic sign in response to receiving the signal.

In some embodiments disclosed herein, a traffic sign and a transmission apparatus are attached to a pole. The transmission apparatus may include a Personal Handy Phone System (PHS) base station apparatus, and may be configured to transmit a signal indicating a presence of the traffic sign to a moving vehicle. The moving vehicle may be an automobile that should be driven to comply with a content of the traffic sign. The signal may have electric power of a PHS transmission output, such as approximately 10 milliwatts (mW) in some examples.

The notification apparatus may include a PHS terminal. The notification apparatus is provided at the above-described moving vehicle, and is configured to receive a signal from the transmission apparatus, and to notify an operator of the moving vehicle, for example, a driver of an automobile, of the presence of the traffic sign in response to receiving the signal.

Technical advantages disclosed in the present application will be apparent to those skilled in the art by reading the following description. Accompanying figures are incorporated into the specification of the present application to form a part thereof and illustrate various embodiments. The accompanying figures should not be construed as drawn to scale unless otherwise noted.

### BRIEF DESCRIPTION OF THE FIGURES

A configuration and an operation of an embodiment disclosed herein will be best understood by referring to the following description and accompanying figures in which:

FIG. 1 illustrates an example of a traffic sign notification system including a transmission apparatus and a notification apparatus according to some embodiments;

FIG. 2 illustrates an example configuration of the transmission apparatus of FIG. 1, including a data generation unit;

FIG. 3 illustrates an example of data that may be generated by the data generation unit of FIG. 2;

FIG. 4 illustrates an example configuration of the notification apparatus of FIG. 1; and

FIG. 5 illustrates operation of the traffic sign notification system of FIG. 1 according to some embodiments.

### DETAILED DESCRIPTION

Hereinafter, an example embodiment will be described in detail. The embodiment disclosed herein is exemplified in the accompanying figures. Although the example embodiment will be described in some detail, those skilled in the art will understand that the example embodiment is not intended to be limiting.

Many variations may be made to the embodiments disclosed herein without departing from the spirit of the present disclosure and various alternatives, changes, and equivalents may be included in the scope of the appended claims.

In addition, the disclosure of the present application is described specifically and in detail so that it can be fully understood. However, as will be understood by those skilled in the art, the disclosure of the present application can be implemented without implementing all the matters described specifically herein.

It is to be noted that known methods, procedures, components, and circuits are not described in detail so as to avoid obscuring the disclosed embodiments. However, it should be kept in mind that these and similar terms may be associated with appropriate physical components, and they are only expediential labels applied to such components.

As is apparent from the following discussion, unless otherwise noted, it is understood that the discussion using terms such as “generate data”, “transmit”, and “receive” refers to functions and processes of hardware resources, such as an electronic circuit, a CPU and a Digital Signal Processor (DSP) throughout the present disclosure.

Hereinafter, an embodiment of the present disclosure will be described.

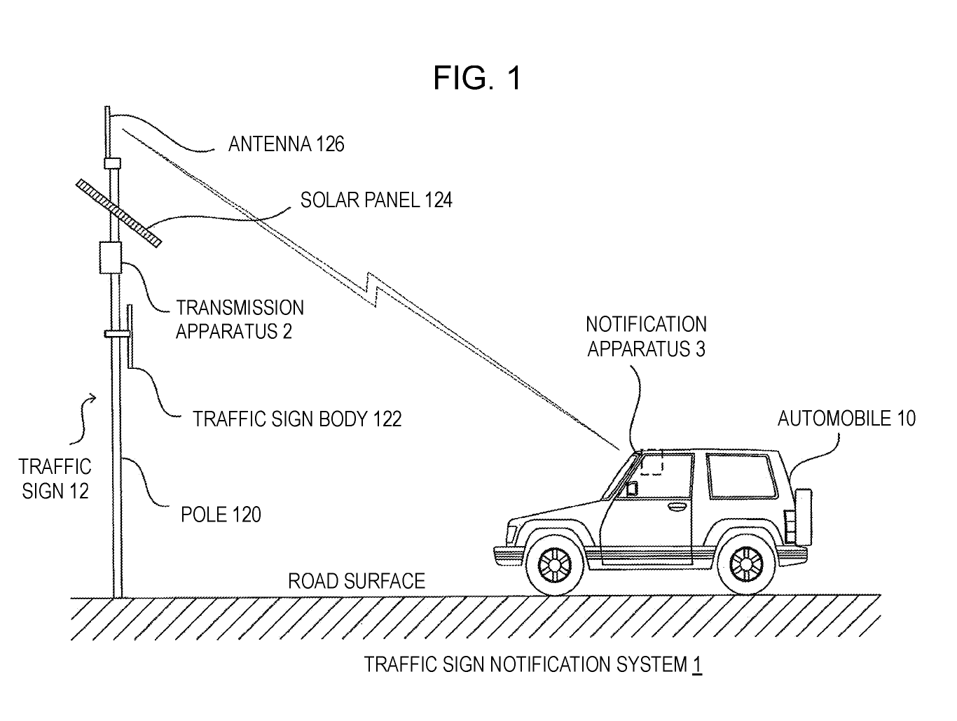

FIG. 1 illustrates an example of a traffic sign notification system 1 according to some embodiments.

As shown in FIG. 1, the traffic sign notification system 1 includes one or more transmission apparatus(es) 2 attached to n length(s) of a pole(s) 120. The pole 120 may be the pole of one or more traffic signs 12. The traffic sign notification system 1 also includes one or more notification apparatuses 3 attached to n respective automobiles 10. In general, the automobile 10 should be driven to comply with a content of a corresponding traffic sign body or bodies 122. The content of the traffic sign body 122 may include, for example, ONE WAY, DO NOT ENTER, STOP, etc. As used herein, “n” is an integer satisfying n≧1, however, n does not necessarily indicate the same number when applied to different components of the traffic sign notification system 1.

Using the above-described components, the traffic sign notification system 1 is configured to notify a driver of the automobile 10 regarding the presence of the traffic sign 12, and to thereby call the driver's attention so that the content of the traffic sign body 122 may not be missed.

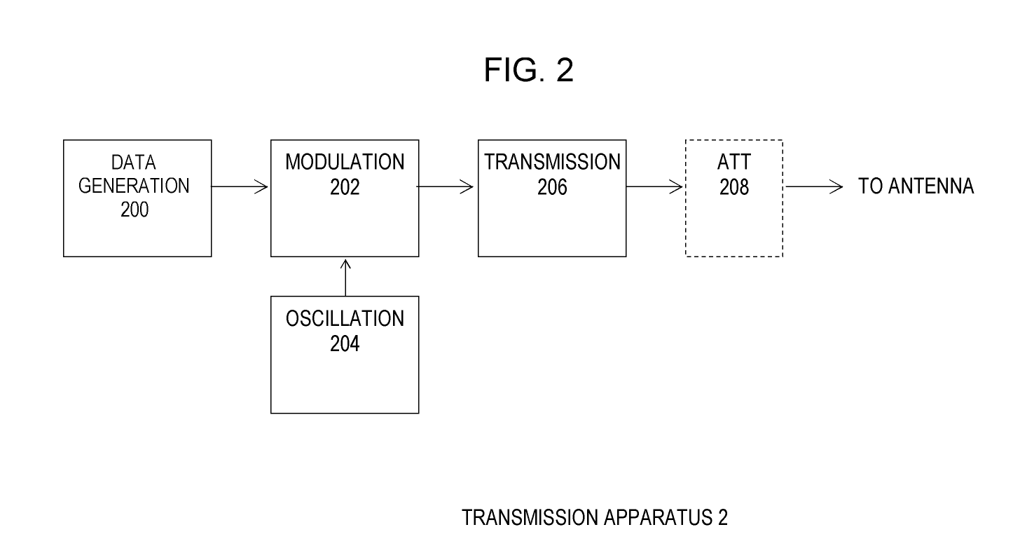

FIG. 2 illustrates an example configuration of the transmission apparatus 2 of FIG. 1.

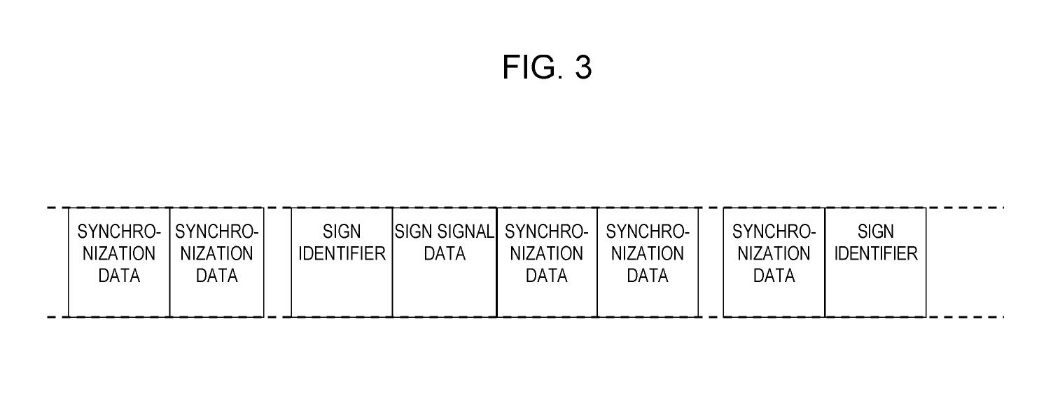

FIG. 3 illustrates an example of data that may be generated by a data generation unit 200 included in the transmission apparatus 2 of FIG. 2.

As shown in FIG. 2, transmission apparatus 2 includes the data generation unit 200, a modulation unit 202, an oscillation unit 204, a transmission unit 206, and an attenuator (ATT) 208. It is understood that the attenuator 208 may be inserted between the transmission unit 206 and an antenna 126 (see FIG. 1) if needed, or can be omitted if not needed.

The transmission apparatus 2 may be configured to operate using electric power supplied by a solar panel 124 attached to the pole 120 of the traffic sign 12 (see FIG. 1) and generated from sunlight. The transmission apparatus 2 is also configured to transmit a signal to the notification apparatus 3 through an antenna 126 attached to a top of the pole 120.

As best seen in FIG. 3, in the transmission apparatus 2, the data generation unit 200 generates data that includes a synchronization signal, sign signal data indicating the presence of the traffic sign 12, and a sign identifier indicating the content of the traffic sign body 122. Returning to FIG. 2, the data generation unit 200 outputs the generated data to the modulation unit 202.

The modulation unit 202 modulates a carrier signal received from the oscillation unit 204 in order to transmit the data received from the data generation unit 200 (see FIG. 3), for example, using a phase-shift keying (PSK) modulation system. The modulation unit 202 outputs a modulated signal resulting from the modulation to the transmission unit 206.

The transmission unit 206 arbitrarily converts a frequency of the modulated signal received from the oscillation unit 204. For example, the transmission unit 206 may amplify the modulated signal to electric power that qualifies as a very weak radio wave by law, and that can be used freely, and then transmits the resulting signal through the antenna 126 provided at the traffic sign 12 (see FIG. 1).

In some embodiments, when the electric power of the signal output by the transmission unit 206 has a value greater than a predetermined value, the attenuator 208 is arbitrarily inserted between the transmission unit 206 and the antenna 126, and the signal is attenuated to have an electric power value suitable for an application of the transmission apparatus 2.

In addition, a frequency of the signal may be, for example, a frequency used for atomic clocks, such as 40 kHz or 60 kHz, or a frequency used for mobile phones, such as 800 MHz or 1.5 GHz, or the like. Alternately, the transmission apparatus 2 may be configured to transmit at a frequency other than those explicitly described above.

In addition, when the frequency of the signal is high, an antenna that has directivity and a high front/back ratio (F/B ratio) may be used as the antenna 126 in the traffic sign notification system 1 of FIG. 1. In these and other embodiments, the directivity of the antenna 126 may be directed in an opposite direction to a traveling direction of the automobile 10, or in an opposite direction to a line of sight of the driver of the automobile 10 as the traffic sign body 122 is approached.

In some embodiments in which the directivity of the antenna 126 is directed as described above, the signal may proceed from a rear direction to a front direction of the traffic sign body 122. As such it may limit the transmission of the signal to automobiles 10 approaching from the front of the traffic sign 12 as opposed to automobiles approaching from other directions.

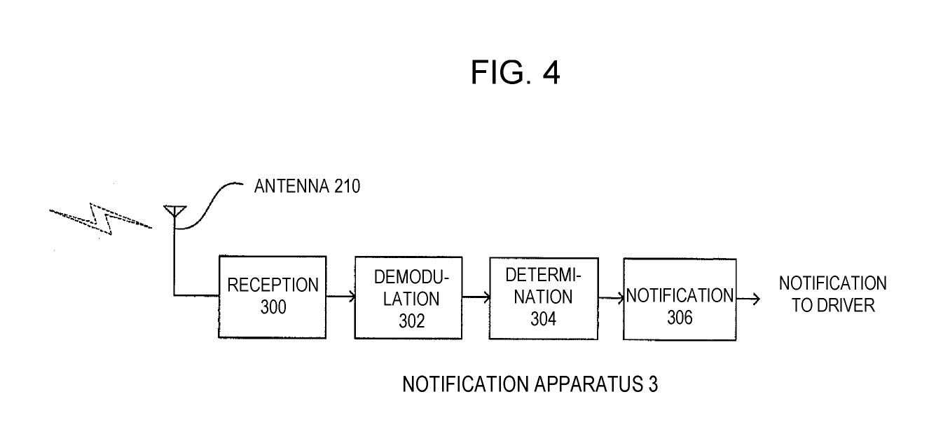

FIG. 4 illustrates an example configuration of the notification apparatus 3 of FIG. 1 according to some embodiments.

As shown in FIG. 4, the notification apparatus 3 includes an antenna 210, a reception unit 300, a demodulation unit 302, a determination unit 304, and a notification unit 306.

With the above-described components, the traffic sign notification apparatus 3 is generally configured to receive a signal transmitted by the transmission apparatus 2, and to notify the driver of the automobile 10 about the presence of the traffic sign 12 by generating a sound, a visual indicator such as a light, a vibration, or a combination thereof, in response to detecting the sign signal data (see FIG. 3) included in the received signal.

In more detail, the reception unit 300 is configured to receive the signal from the transmission apparatus 2 through the antenna 210, and to arbitrarily convert and amplify a frequency of the signal to output to the demodulation unit 302.

The demodulation unit 302 is configured to demodulate the signal received from the reception unit 300, and to output a demodulated signal to the determination unit 304.

The determination unit 304 is configured to process data included in the demodulated signal, and to synchronize it using synchronization data included therein (see FIG. 3) to extract sign signal data and a sign identifier from the demodulated signal.

Further, after the sign signal data are extracted from the demodulated signal received from the demodulation unit 302, the determination unit 304 controls the notification unit 306 to generate a notification regarding the presence of the traffic sign 12 to the driver of the automobile 10.

The notification unit 306 may include, for example, a buzzer, light emitting diode (LED), a vibrator, or the like or any combination thereof. In the case of an audible notification, the frequency of the notification may be approximately 3 kHz and the volume may be approximately 70 dB. Thus, the notification unit 306 may be controlled by the determination unit 304 to notify the driver of the automobile regarding the presence of the traffic sign 12 using a sound, a light, or a vibration, or a combination thereof.

Accordingly, the driver of the automobile 10 may be alerted to the presence of the traffic sign 12 by the notification, and may then find the traffic sign 12 and recognize the content of the traffic sign body 122.

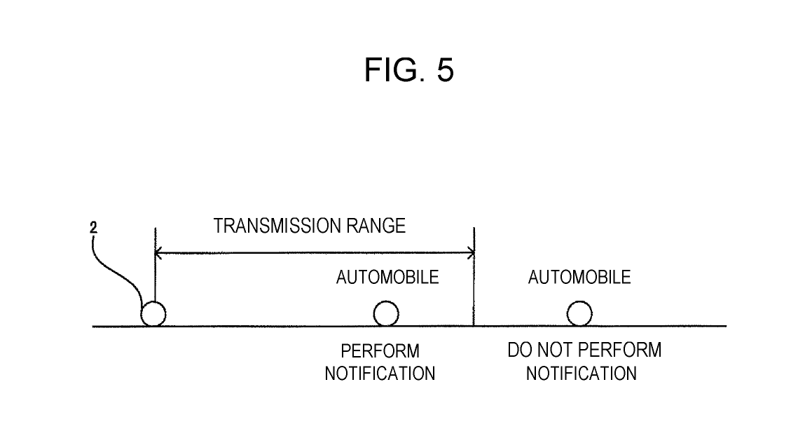

FIG. 5 illustrates operation of the traffic sign notification system 1 of FIG. 1 according to some embodiments.

As shown in FIG. 5, if a distance between the transmission apparatus 2 and the automobile 10 including notification apparatus 3 falls within a transmission range of the signal suitable for receiving the signal and extracting the corresponding data, i.e., when the distance is shorter than a signal reach distance, the notification apparatus 3 notifies the driver of the automobile 10 regarding the presence of the traffic sign 12.

Alternately, if the distance between the transmission apparatus 2 and the automobile 10 is beyond the transmission range of the signal that is suitable for receiving the signal and extracting the corresponding data, the notification apparatus 3 does not notify the driver of the automobile 10 regarding the presence of the traffic sign 12.

In some embodiments, the above-mentioned transmission range can be set at an appropriate distance for drivers of automobiles 10 by adjusting the transmission unit 206 or the attenuator 208 of the transmission apparatus 2 of FIG. 2, and/or by optimizing the directivity of the antenna 126 of FIG. 1.

In some embodiments, it may be beneficial for the traffic sign notification system 1 to limit a maximum communication distance between the transmission apparatus 2 and the notification apparatus 3. In these and other embodiments, the traffic sign notification system 1 may implement various components of a PHS using a number of microcells with a transmission radius of approximately several tens of meters to 100 meters.

Hereinafter, a case will be described as a specific example where a PHS base station, at which voice data of approximately 32 kbps can be transmitted to/from a PHS terminal using a signal of 1.9 GHz bands by, e.g., Adaptive Differential Pulse-Code Modulation (ADPCM), is used as the transmission apparatus 2, and a PHS terminal is used as the notification apparatus 3.

In this case, when the PHS terminal (e.g., the notification apparatus 3) enters a microcell centering on the PHS base station (e.g., the transmission apparatus 2) attached to the traffic sign 12, the PHS terminal may be automatically connected to the PHS base station to be in a state where a voice can be output therefrom.

Further, the PHS base station may supply to the connected PHS terminal a voice signal that the PHS terminal can output to notify the driver of the automobile 10 regarding the presence of the traffic sign 12.

As an experiment, when the PHS base station and the PHS terminal mounted on the automobile 10 were connected to each other in advance, and a voice could be output from the PHS terminal, drivers of six automobiles 10 could hear the voice notification at a distance of approximately several tens of meters to 100 meters in a direct line from the PHS base station mounted on the traffic sign 12.

In some embodiments, when a sign identifier is included in a signal (see FIG. 3) in the traffic sign notification system 1, a content of the notification generated by the notification apparatus 3 may be changed depending on the content of the traffic sign body 122 indicated by the sign identifier.

In some embodiments, the notification apparatus 3 can be incorporated into a car stereo, a navigation apparatus, etc. of the automobile 10.

The above-described embodiments are presented for illustration and explanation, and may not encompass all embodiments within the scope of the appended claims.

In addition, the above-described embodiments are not intended to limit the technical scope of the present disclosure. Further, the above-described embodiments can be variously changed and modified as will be understood by those of skill in the art in light of the present disclosure.

In addition, the above-described embodiments were selected and described to set forth the principles of the present disclosure and practical applications thereof. As such, those skilled in the art can utilize the present disclosure and the embodiments thereof by adding various changes to them to make them most suitable for every possible practical application as desired.

In addition, the technical scope of the present disclosure is intended to be demarcated by descriptions and equivalents thereof.

The embodiments of the present disclosure can be used to notify operators of moving vehicles (for example, an automobile, a motorcycle, etc.) regarding the presence of a traffic sign so that the operators are aware of and can comply with a content of the traffic sign.

What is claimed is:

1. A traffic sign notification system comprising:
a transmission apparatus provided at a position related to a traffic sign, the transmission apparatus configured to transmit a signal indicating a presence of the traffic sign; and
a notification apparatus provided at a moving vehicle, the notification apparatus comprising:
a reception unit configured to receive a signal transmitted by the transmission apparatus; and
a notification unit configured to generate a notification regarding the presence of the traffic sign in response to receiving the signal.

2. The traffic sign notification system according to claim 1, further comprising a solar panel configured to supply electric power to the transmission apparatus.

3. The traffic sign notification system according to claim 1, wherein:
the transmission apparatus is configured to transmit a voice signal to the notification apparatus in the signal indicating the presence of the traffic sign; and
the notification unit of the notification apparatus is configured to output the voice signal as the notification regarding the presence of the traffic sign.

4. The traffic sign notification system according to claim 3, wherein the transmission apparatus and the notification apparatus are Personal Handy Phone System (PHS) terminals.

5. The traffic sign notification system according to claim 1, wherein the transmission apparatus is a Personal Handy Phone System (PHS) base station and the notification apparatus is a PHS terminal.

6. The traffic sign notification system according to claim 1, wherein the transmission apparatus is configured to transmit the signal with directivity directed in an opposite direction to a traveling direction of the moving vehicle.

7. The traffic sign notification system according to claim 1, wherein a frequency of the signal is about 40 kHz, about 60 kHz, about 800 MHz, or about 1.5 GHz.

8. The traffic sign notification system according to claim 1, wherein the notification regarding the presence of the traffic sign generated in response to receiving the signal includes at least one of a sound, a visual indicator, or a vibration.

9. The traffic sign notification system according to claim 8, wherein the sound has a frequency of approximately 3 kHz and a volume of approximately 70 dB.

10. The traffic sign notification system according to claim 1, wherein the notification unit includes at least one of a buzzer, a light emitting diode, or a vibrator.

11. The traffic sign notification system according to claim 1, wherein the signal transmitted by the transmission apparatus has a predetermined electric power of about 10 milliwatts (mW).

12. The traffic sign notification system according to claim 1, wherein the transmission apparatus includes:
a data generation unit configured to generate data;
an oscillation unit configured to generate a carrier signal;
a modulation unit coupled to the data generation unit and the oscillation unit and configured to modulate the generated data onto the carrier signal; and
a transmission unit coupled to the modulation unit and configured to convert a frequency of the modulated signal from a first frequency to a second frequency.

13. The traffic sign notification system according to claim 12, wherein the transmission apparatus further includes an attenuator coupled to the transmission unit and configured to attenuate the converted signal output by the transmission unit.

14. A method comprising:
transmitting a signal including sign information indicating a presence of a traffic sign from a position related to the traffic sign to a moving vehicle approaching the sign;
receiving the transmitted signal at the moving vehicle; and
in response to receiving the transmitted signal, generating a notification regarding the presence of the traffic sign.

15. The method of claim 14, further comprising, prior to transmitting the signal:
generating data including synchronization data and the sign information, the sign information including sign signal data indicating the presence of the traffic sign and a sign identifier indicating content of the traffic sign;
modulating a carrier signal with the generated data to produce a modulated signal;
converting the modulated signal from a first frequency to a second frequency; and
emitting the converted signal through an antenna as the transmitted signal.

16. The method of claim 15, further comprising, prior to emitting the converted signal:
determining that the converted signal has a power above a predetermined value; and
attenuating the converted signal to have a power below the predetermined value.

17. The method of claim 15, wherein modulating the carrier signal with the generated data to produce a modulated signal includes modulating the carrier signal with the generated data according to a phase-shift keying (PSK) modulation system.

18. A notification apparatus comprising:
a reception unit configured to receive a signal transmitted from a transmission apparatus, wherein the signal indicates a presence of a traffic sign; and
a notification unit configured to generate a notification regarding the presence of the traffic sign in response to receiving the signal.

19. The notification apparatus of claim 18, further comprising:
a demodulation unit coupled to the reception unit, the demodulation unit configured to demodulate an output of the reception unit representative of the received signal and to output a demodulated signal; and
a determination unit coupled to the demodulation unit, the determination unit configured to process data included in the demodulated signal and control the notification unit to generate the notification.

20. The notification apparatus of claim 18, wherein the signal is an Adaptive Differential Pulse-Code Modulation (ADPCM) signal.
